(19) United States
(12) Patent Application Publication
(10) Pub. No.: US 2015/0221171 A1
(43) Pub. Date: Aug. 6, 2015

(54) GAMING METHOD AND ASSOCIATED APPARATUS

(71) Applicant: Garry Roald Ohlson, North Sydney (AU)

(72) Inventor: Garry Roald Ohlson, North Sydney (AU)

(21) Appl. No.: 14/557,463

(22) Filed: Dec. 2, 2014

(30) Foreign Application Priority Data
Jan. 31, 2014 (AU) 2014900286

(51) Int. Cl. G07F 17/32

(52) U.S. Cl. CPC G07F 17/3244

(57) ABSTRACT

The present invention relates to a gaming method, apparatus and system associated with gaming based wagering activities. The gaming method relates to an event having a number of event participants, wherein the event determines a finishing order for at least some event participants. The method determines the eligibility for a dividend for each wager made on an event participant that finishes within the top n finishing positions.

### CROSS-REFERENCE TO RELATED APPLICATIONS

This application claims the benefit of Australian provisional application No. 2014900286 filed on Jan. 31, 2014.

### BACKGROUND OF INVENTION

1. Field of Invention

The present invention relates to a gaming method, apparatus and system associated with gaming based wagering activities. Embodiments of the present invention find application, though not exclusively, in gaming contexts such as horse racing and other racing-based wagering activities.

2. Description of Prior Art

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in Australia or elsewhere before the priority date of this application. Wagering on horse races has been into existence since the horses have been running. It's been a popular sport worldwide and has been profitable if the bettor predicts the outcome correctly. While there are existing patents discussing various methods and systems for providing Parimutuel betting options and payouts but none of them talks about the graduated dividends scheme. The present invention comprises a system and method to distribute payouts to the wagers in the form of graduated dividends. As per the algorithms applied in the present invention, there is an inverse relationship between each of the top n finishing positions in the tournament and a prize amount or dividend respectively associated with each of the top n finishing positions.

U.S. Pat. No. 8,292,729 to Vlazny et al. (2012) talks about methods and systems of parimutuel wagering. The patent primarily focuses on ‘All Up’ wagering style wherein the winnings of one race are automatically reinvested to another with the aim of returning a larger overall payout. On the contrary applicant's invention addresses a graduating or reducing dividend scheme without investing the winnings of one race into another. AU Pat. No. 2013200328 to Racing and Wagering Western Australia (2014) relates to a wagering system with underlying time sensitive redeemable units. The user may enter in the set of wagering information through a graphical user interface. The wager processor calculates the potential return for a wager based on the value of the non-redeemed portion of all amounts wagered on the outcome minus a commission amount. This system pays pari-mutuel dividends to the wagers with fixed odds i.e. the bookmaker will make a contract with a bettor at a fixed rate of return for a fixed amount of money risked. On the contrary, applicant's invention addresses a reducing dividend scheme for other finishers in the competition. Furthermore, applicant's invention does not allow fixing dividends prior to the actual event. Another U.S. Pat. No. 8,342,959 to Mahaffey et al. (2013) addresses the system directed to a method for pari-mutuel betting wherein the method includes collecting wagers from the gamblers, accepting predictions from the gambler for discreet events, forming a pool from the wagers and allocating points to the gamblers based upon the predictions and determining rankings of the gamblers based upon the points allocated thereto and distributing the pool according to the rankings. On the other hand, applicant's method and system not only utilizes the reducing dividend scheme but also does not allow point's allocation to the betters or any kind of ‘in-play’ wagering.

Yet another AU Pat. Application No. 2013204770 to Tabcorp International (2013) discusses about the wagering system wherein the participants choose how much they want to bet substantially independent of the number of combinations involved with the bet being placed, and dividends are determined based on the quantum of the wager amount relative to the number of combinations selected by the participants. This system also enables players to wager on the outcome of multiple gaming events. On the contrary, applicant's invention does not allow complex exotic betting types like trifecta, superfecta, quadrella etc. Applicant's wagering system primarily focuses on calculating reducing dividends or payouts. While all the abovementioned patents fulfil their intended purpose but do not present a wagering method and sytem for calculating reducing dividends or payouts for other finishers in the race. Hence, the present invention is a substantial improvement over the existing patents in this field.

### SUMMARY OF THE INVENTION

It is an object of the present invention to overcome, or substantially ameliorate, one or more of the disadvantages of the prior art, or to provide a useful alternative.

In one aspect of the present invention there is provided a gaming method relating to an event having a number of event participants, wherein the event determines a finishing order for at least some event participants, the method including:

prior to the event, defining a constant integral number n that is less than the number of event participants and that is greater than, or equal to, two;

prior to the event, accepting a plurality of wagers, each of the wagers being on at least one of the event participants; and subsequent to the event, being responsive to a top n of the finishing order so as to determine eligibility for an award for each wager made on an event participant that finished within the top n finishing positions;

wherein an inverse relationship exists between each of the top n finishing positions and a prize or dividend amount respectively associated with each of the top n finishing positions.

In one embodiment each of the prize amounts respectively associated with each of the top n finishing positions is a pool amount available to be paid out across each wager on one of the top n finishing positions. In this embodiment a base prize pool amount Pₙ is associated with the n^{th} finishing position and a prize pool amount Pₚ is associated with the p^{th} finishing position, where p is less than n, the prize pool amount Pₚ being given by the following formula:

Pₚ=Pₙ×Fₚ

where Fₚ is a factor that is inversely related to p. Preferably Fₚ is inversely proportional to p.
In one embodiment factor Fₚ is given by the following formula:

Fₚ=n+1−p.

In another embodiment factor Fₚ is given by the following formula:

Fₚ=(n+1−p)².

Preferably the base prize pool amount Pₙ is given by the following formula:

Pₙ=T÷N

T being a total available prize pool; and
N being given by the following formula:

N=n(n+1)÷2

Preferably the total available prize pool is equal to a total amount wagered minus a withheld amount. Preferably the withheld amount includes an operator's profit amount, a costs amount and a tax amount.

In another embodiment each of the prize amounts respectively associated with each of the top n finishing positions is a win dividend that determines a payout amount that is payable for each wager on a competitor that finishes in one of the top n finishing positions. In this embodiment a base dividend Dₙ is associated with the n^{th} finishing position and a dividend Dₚ is associated with the p^{th} finishing position, where p is less than n, the win dividend Dₚ being given by the following formula:

Dₚ=Dₙ×Fₚ

where Fₚ is a factor that is inversely related to p.
Preferably the base dividend associated with the n^{th} finishing position is calculated by defining a total dividend T and dividing T by n(n+1)÷2

An embodiment of the gaming method includes the alteration of at least some of the dividends in response to market conditions during a period in which wagers are being accepted. In another embodiment the dividends remain fixed during a period in which wagers are being accepted.

According to yet another aspect of the invention there is provided a computerised apparatus for implementing a gaming method relating to an event having a number of event participants, wherein the event determines a finishing order for at least some event participants, the computerised apparatus being programmed to:

store a constant integral number n that is less than the number of event participants and that is greater than, or equal to, two;

store a plurality of wagers, each of the wagers being on at least one of the event participants; and

process a top n of the finishing order so as to determine eligibility for a dividend for each wager made on an event participant that finished within the top n finishing positions;

wherein an inverse relationship exists between each of the top n finishing positions and a dividend amount respectively associated with each of the top n finishing positions.

The features and advantages of the present invention will become further apparent from the following detailed description of preferred embodiments, provided by way of example only, together with the accompanying drawings.

### BRIEF DESCRIPTION OF DRAWINGS

FIG. 1 is a flowchart illustrating steps implemented in the first preferred embodiment of the gaming method.

FIG. 2 is a flowchart showing steps implemented in the second preferred embodiment of the gaming method.

FIG. 3 illustrates a system for implementing preferred embodiments of the gaming method.

FIG. 4 shows a screenshot of Sum Wagering™ calculator.

FIG. 5 illustrates an example of Sum Wagering™ calculator calculating dividends.

FIG. 6 shows a Sum Wagering™ ticket.

### DETAILED DESCRIPTION OF PREFERRED EMBODIMENTS

A first embodiment of the gaming method relates to an event in the form of a golfing tournament having a number of event participants, which, for the sake of a worked example, we shall assume to be 100. For identification purposes, assume that each golfing participant is identified by an identification number, ranging between 1 and 100.

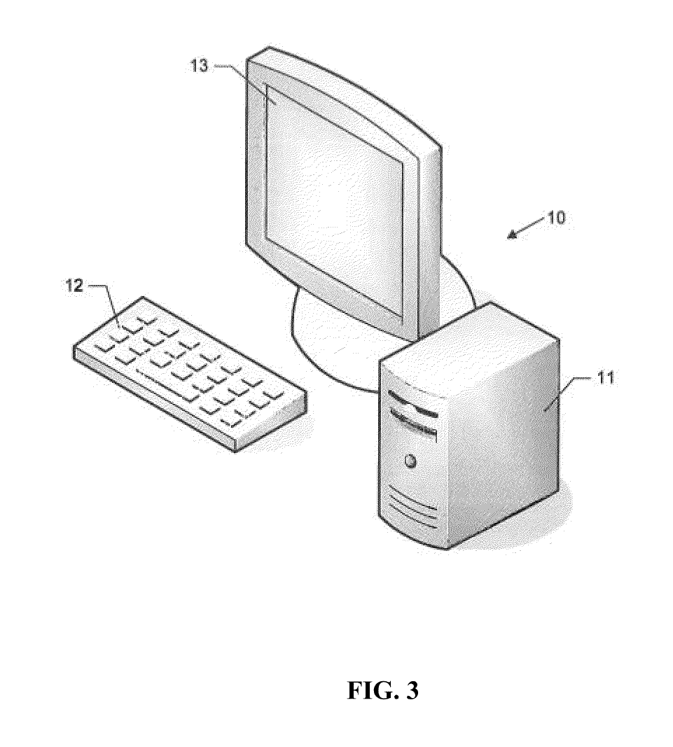

The gaming method may be implemented upon a computing platform, such as the computer 10 shown in FIG. 3 for example, that is programmed to perform the required processing. This computing apparatus has a server 11 housing a central processing unit (CPU); associated memory, for example RAM and ROM; storage devices such as hard drives, writable CD ROMS and flash memory; and a communications link in the form of a modem. The computer 10 also includes input devices such as a keyboard 12 and mouse; output devices, for example a printer; a display in the form of a screen 13.

It will be appreciated that the actual computing platform upon which the invention is implemented will vary depending upon the amount of processing power required. In some embodiments the computing apparatus is a stand alone computer, whilst in other embodiments the computing apparatus is formed from a networked array of interconnected computers. Additionally, the terms “computer”, “computing apparatus” and the like as used in this patent specification, including in the claims, are to be construed in a broad manner so as to include any device capable of the necessary processing, having access to sufficient data storage capacity and possessing a suitable input device. Non-limiting examples of such devices include mobile phones, personal digital assistants, tablets, information kiosks and the like.

The gaming method may be embodied in computer software in the form of executable code for instructing the computer to perform the inventive method. The software and its associated data are capable of being stored upon a computer-readable medium, for example in the form of one or more non-transitory compact disks. Alternative embodiments make use of other forms of digital storage media, such as Digital Versatile Discs (DVD's), hard drives, flash memory, Erasable Programmable Read-Only Memory EPROM, and the like. Alternatively the software and its associated data may be stored as one or more downloadable or remotely executable files that are accessible via a computer communications network such as the internet. Mobile phone apps are examples of downloadable files. Programs executed in a cloud computing context provide examples of remotely executable files.

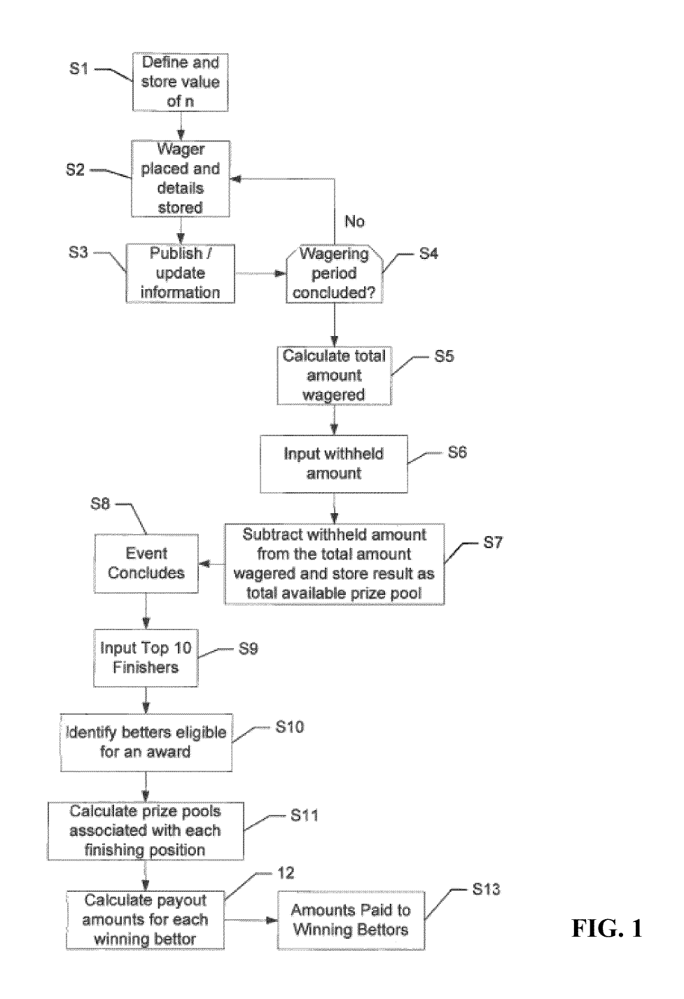

With regard to the process flow depicted in FIG. 1, prior to the running of the golfing tournament, at step S1, the gaming operator defines an integral number n, which is kept constant for the purposes of the gaming method as applied to the golfing tournament. This number must be less than the number of event participants (i.e. less than 100 in this example) and it must be greater than, or equal to, two. Say, for the sake of the running example, that the operator defines n=10. This means that the operator is offering to pay out a dividend for each wager made on a golfing participant that finishes within the top 10 finishing positions in the golfing tournament. The value of n is entered into the computer 10, which is programmed to store this value for future processing in the RAM, or upon the hard drive, of the computer 10.

At step S2 of FIG. 1, prior to the running of the golfing tournament, bettors are invited to wage on a participant. Wagers may be placed by the bettor marking up a suitable wagering card and presenting it at a wager receiving centre. The bettor pays the applicable wager's amount, the card is scanned and the details of the bettor's wager are communicated to the computer 10 (as seen in FIG. 3) via a secure online connection. The computer 10 then stores the details of the wager on its hard drive for future processing. Alternatively, the bettor may use his or her own computing equipment to log into a web site that is hosted by the operator's computer 10. The bettor makes suitable inputs so as to identify his or her information identifying the venue, event number, the intended wager and possibly “n” which will indicate the number of finishing positions for which the bettor will collect a dividend. The bettor pays the wagered amount to the operator via an electronic transaction. The details of the bettor's wager are then captured and stored by the computer 10 for future processing. Each wager identifies a golfer participating in the golfing tournament that the bettor believes is likely to finish within the top ten. The details of each wager or bet that are stored by the computer 10 include the information identifying the venue, event number, the intended wager and possibly “n” indicating the number of finishing positions and the golfer upon whom the bettor has chosen to place a wager or a bet, along with the amount of the wager and optionally an identifier of the bettor that placed the wager. These details are printed on a ticket, or recorded on another information storage device, such as a mobile phone, which is retained by the bettor. Additionally, these details are stored on the hard drive of the computerised system 10 that is administered by the gaming operator.

Whilst the wagers are being placed, at step S3 of FIG. 1, the operator's computer is programmed to publish information, for example on a tote board and/or online, to assist bettors to select a player on which to wager. This includes the amount of dividends which the bettors collect for correctly selecting one of the top 10 competitors. In its most detailed form, this includes a list of each competitor in the golfing tournament, along with 10 amounts that represent the return that the bettors would receive per dollar wagered if they back that competitor and if that competitor finishes in one of the top 10 finishing positions. Alternatively, to minimise the amount of information displayed, the operator may choose to display only the amounts that the bettor will receive for each competitor that they wagered on that finishes 10^{th}.

The bettors can then multiply this amount by the appropriate factor to calculate the return for positions 9^{th} through to 1^{st}. Yet another alternative is to publish only the amounts that the bettor will receive for each competitor finishing 1^{st}. The bettors can then divide this amount by the appropriate factor to calculate the return for positions 2^{nd} through to 10^{th}. A further alternative is to inform the bettors of the size of either the total prize pool, or the individual prize or dividend pools associated with each finishing position, and to state that if their wager is successful, they will share in one of those pools.

The operator's computer 10 calculates this information by utilising the calculations discussed in detail below. The amounts shown on such a list are instantaneous amounts that will change as additional wagers are placed. This is because additional wagers will alter both the total prize pool and the number of successful bettors across which an individual prize pool must be divided. As additional wagers are placed, the information shown on the tote board is updated. Bettors are informed that the actual return that they receive is likely to vary from the return shown at any particular time on the tote board. However, as the wagering period draws to a close, the figures shown on the tote board is likely to converge to the actual figures that will be paid out for the various eventualities.

As the process flow repeatedly loops around steps S2 and S3, a plurality of wagers are accepted and the published information is progressively updated based on the wagers that have been placed to date. At a predefined point relative to the commencement of the tournament, the operator stops accepting any further wagers. This is determined at the loop limiting step S4.

For the running golf example, we shall assume that the total amount wagered by all of the bettors on the golfing tournament was $5,000,000. This figure is calculated at step S5 by the computer 10 by accessing the details stored on the hard drive in relation to each wager and summing the amounts of each wager. From the total amount wagered the gaming operator withholds an amount to cover the operator's profit, costs and tax. Assume for the running example that the amount withheld is $500,000. At step S6 this amount is entered into the computer 10 by the operator using keyboard 12 (as seen in FIG. 3) and at step S7 the computer's processor subtracts the withheld amount from the total amount wagered. This leaves a total available prize or dividend pool (i.e. the total amount wagered minus the withheld amount) of $4,500,000, which is stored in the computer's memory, or other storage means accessible to the computer 10, for further processing. It will be appreciated by those skilled in the field of gaming that the total available prize or dividend pool is calculated on a pari-mutuel basis.

For the running example, we shall assume that by the conclusion of the golfing tournament at Step S8, 94 of the original 100 participants finish the event, with the top 10 of the finishing order being as follows:

| Finishing Position | Participant Identity Number |
|---|---|
| 1^{st} | Participant 67 |
| 2^{nd} | Participant 11 |
| 3^{rd} | Participant 98 |
| 4^{th} | Participant 2 |
| 5^{th} | Participant 54 |
| 6^{th} | Participant 70 |
| 7^{th} | Participant 10 |
| 8^{th} | Participant 16 |
| 9^{th} | Participant 89 |
| 10^{th} | Participant 27 |

Once the finishing order has been established at the conclusion of the golfing tournament, the top 10 is entered into the computer 10 at step S9. At step S10 the computer then processes the top 10 finishing order in relation to the previously stored details regarding the wagers that were placed to identify the bettors that are eligible for a dividend by checking if the golfer upon which bettor placed a wager had a finishing position within the top 10. If so, the bettor is eligible for an award. In this manner the computer 10 compiles data detailing all bettors who are eligible for a dividend. This data also includes an indication for each winning bettor of the finishing position achieved by the golfer upon whom they wagered.

An inverse relationship exists between each of the top 10 finishing positions and the associated prize or dividend pool amount. That is, the prize pool amount associated with wagers placed upon the golfer that finished 10^{th} is the smallest, with the prize pools progressively increasing as the finishing position decreases. Hence, the prize pool associated with wagers placed upon the golfer that finished 1^{st} is the largest.

The base dividend pool amount, which may be signified as P₁₀, is the dividend pool that is available to be paid out to all bettors that backed Participant 27 (i.e. the golfer who came 10^{th} in the tournament). The base dividend pool amount is given by the following formula:

P₁₀=T÷N.

T is the total available dividend pool (i.e. $450,000 in the running example) and N is given by the following formula:

N=n(n+1)÷2.

Hence, in the running example; N=55 and P₁₀=$81,818.18.
To calculate the remaining dividend pools (i.e. the prize pools associated with finishing positions 1 to 9, which are referred to herein as P₁ to P₉), the gaming operator uses the following formula to calculate the dividend pool Pₚ that is associated with wagers place on golfers finishing in the p^{th} finishing position:

Pₚ=P₁₀×Fₚ.

Fₚ is a factor that is inversely related to p and more particularly Fₚ is inversely proportional to p. The factor Fₚ is given by the following formula:

Fₚ=n+1−p.

At step S11 of FIG. 1 the processor of the computer 10 uses these formulas to calculate the figures shown in this table:

| Finishing Position | | Associated Prize/Dividend |
|---|---|---|
| (p) | Factor Fₚ | Pool Pₚ |
| 1 | 10 | $818,181.81 |
| 2 | 9 | $736,363.63 |
| 3 | 8 | $654,545.45 |
| 4 | 7 | $572,727.27 |
| 5 | 6 | $490,909.09 |
| 6 | 5 | $409,090.90 |
| 7 | 4 | $327,272.72 |
| 8 | 3 | $245,454.54 |
| 9 | 2 | $163,636.36 |
| 10 | 1 | $81,818.18 |

The inverse relationship between finishing position p and the associated prize or dividend pool Pₚ can be clearly seen in the above table. That is, as finishing position p increases, the associated prize pool Pₚ decreases.

As can be seen from the above table, a prize pool of $818,181.81 is available to be divided amongst those bettors who selected Participant 67, who is the golfer that won the tournament. A prize pool of $736,363.63 is available to be distributed to those bettors who selected Participant 11, who is the golfer that finished second in the tournament. This reduces progressively down to the base prize pool amount of $81,818.18, which is available to be distributed to those bettors who selected Participant 27, who is the golfer that finished 10^{th} in the tournament.

The actual payout amount paid to each winning bettor will depend upon: the amount of the prize or dividend pool in which they are entitled to share; the amount that they wagered; and upon the number of other bettors that also wagered on the same participant. All of this data has been stored by the computer 10, which calculates the payout amounts for each of the winning bettors at step S12. For the sake of the running example, assume that a total of 4 bettors wagered on Participant 16, who finished 8^{th}. The prize pool that is available to be distributed amongst those 4 bettors is $245,454.54. This prize pool is paid out in proportion to the amount bet by each of those 4 bettors, as shown in this table:

| | | Prize/Dividend Awarded |
|---|---|---|
| Bettor | Amount Wagered | to Bettor |
| 1 | $100 | $15,835.77 |
| 2 | $50 | $7,917.89 |
| 3 | $400 | $63,343.11 |
| 4 | $1000 | $158,357.77 |

The individual prizes or dividends are calculated by first adding the amounts wagered by each of the 4 bettors, which in this case gives $1550. Then, a fraction is calculated in which the numerator is the amount wagered by the bettor and the denominator is the total wagered by each of the 4 bettors. Hence for Bettor 1, the fraction is 100/1550. Finally, the prize pool amount of $245,454.54 is multiplied by this fraction. Hence, the prize awarded to Bettor 1 is $15,835.77, and so forth for each of the other bettors. The computer 10 performs these calculations to determine the payout amounts for each of the bettors that wagered on golfers that finished in all of the top 10 finishing positions and this data is stored on the computer's hard drive. At step S13 the payout amounts are paid out to the winning bettors, which concludes this embodiment of the gaming method.

In the above-described running example there was an inversely proportional relationship between the finishing position p and the associated prize or dividend pool Pₚ. However, in other embodiments alternative inverse relationships may be utilised provided that as the finishing position decreases, the associated prize pool increases. For example, in another embodiment factor Fₚ is given by the following formula:

Fₚ=(n+1−p)².

This creates an inverse relationship between the finishing position p and the associated prize or dividend pool Pₚ in which the prize pools are more heavily skewed towards favouring the bettors who placed wagers on the higher placed participants. It will be appreciated that other mathematical formulas may be formulated so as to produce various inverse relationships in other embodiments of the invention.

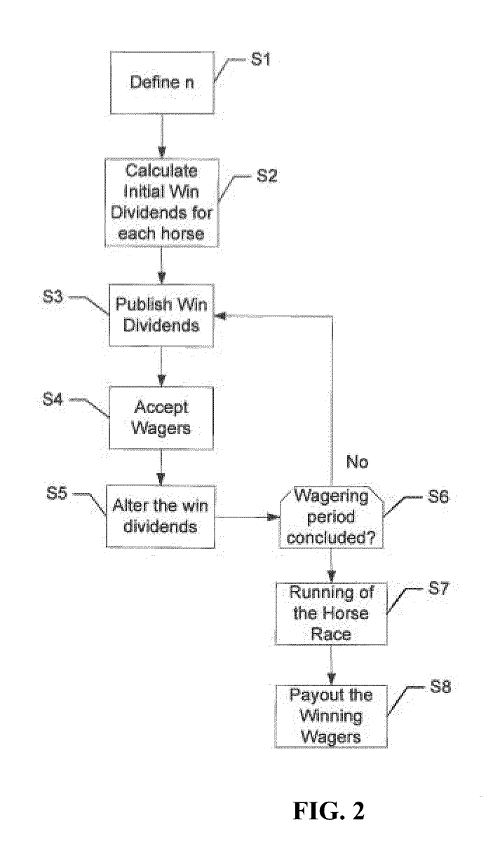

The above described embodiment calculated prize or dividend pools based on a pari-mutuel basis. However, other embodiments may utilise alternative schemes for calculating the pay out amounts. The embodiment as illustrated in FIG. 2 will be described in the context of a bookmaker taking wagers on a horse race with 14 runners. For this embodiment the dividend amounts respectively associated with each of the top n finishing positions are not prize pools as was the case previously. Rather, for this embodiment the dividend amounts respectively associated with each of the top n finishing positions are dividends that determine payout amounts available to be paid out for each wager on a participant that finishes in one of the top n finishing positions.

Prior to the race, at Step S1 of FIG. 2, the bookmaker defines a constant integral number n that is less than 14 (i.e. the number of horses running in the race) and that is greater than, or equal to, 2. Of course, some bookmakers may choose to offer multiple options, with separate books being kept for differing integral n values, such as 2, 3, 4, 5, etc. However, for the sake of describing a running example, we shall assume that the bookmaker selects n=4. This means that the bookmaker will pay out against wagers placed on any horse that places in a top 4 finishing positions.

At step S2 of FIG. 2, the bookmaker calculates initial win dividends, D₁, D₂, D₃, D₄, for each horse, which inform potential bettors of the return associated with a wager on that horse if that horse finishes 1^{st}, 2^{nd}, 3^{rd} or 4^{th} respectively. Firstly, the bookmaker selects an initial total win dividend T, which will be equal to the sum of the win dividends for each of the top n finishing positions. That is, T will be equal to:

$$T = {\sum }_{i = 1}^{i = n} {D}_{i}$$

For horses that the bookmaker considers likely to be favoured runners the bookmaker may select a lower initial total win dividend T. For horses considered by the bookmaker to be less likely to succeed, the bookmaker may select a higher initial total win dividend T. Overall, the bookmaker will select a value for T for each horse with the aim of covering the bookmaker's costs, taxes and to provide a profit margin. For our running example we shall assume that the bookmaker selects $5.00 as the initial total win dividend T for a particular horse. To calculate the initial base win dividend D₄ (i.e. the win dividend associated with the particular horse finishing in 4^{th} position), the bookmaker divides T by N; i.e. T÷N, wherein N=n (n+1)/2. In this example T=$5.00 and n=4, hence in this example D₄ equals $0.50. This means that in return for each $1.00 wagered on the 4^{th} placed horse, the bettor will receive $0.50, when T=$5.00.

In general, to calculate the initial win dividend Dₚ that is associated with the p^{th} finishing position for a particular horse, the bookmaker multiplies the initial base win dividend Dₙ by a factor Fₚ. The factor Dₚ is given by formula:

Dₚ=Dₚ×Fₚ

The factor Fₚ is given by the following formula:

Fₚ=n+1−p.

Hence, the initial win dividend D₃ that is associated with the particular horse finishing in 3^{rd} position is $0.50×2, which is equal to $1.00. Hence, in this example, a player will win their initial wagered amount back if they had placed a wager on the 3^{rd} placed horse. The initial win dividend D₂ that is associated with the particular horse finishing in 2^{rd} position is $0.50×3, which is equal to $1.50. Hence, in return for a wager on the 2nd placed horse, the bettor will receive a payout of 1.5 times the amount originally wagered. The initial win dividend D₁ that is associated with the particular horse finishing in 1^{st} position is $0.50×4, which is equal to $2.00. Hence, a bettor that wagered on the winning horse will receive a payout of double the amount originally wagered. It can be seen that an inverse relationship exists between each of the top 4 finishing positions and their respective win dividends. As expected, the sum of the initial win dividends D₁+D₂+D₃+D₄ is $5.00, as per the amount that was selected for T.

This process is repeated until the bookmaker has determined initial win dividends D₁, D₂, D₃ and D₄ for each of the horses that are to run in the race. At step S3 of FIG. 2 the bookmaker publishes these win dividends and at step S4 commences accepting wagers from various bettors. Each of the wagers is on a particular horse (or a plurality of horses) and the details of each wager are recorded. It will be appreciated that as an alternative to publishing the win dividends, the bookkeeper may choose to publish odds calculated from the win dividend. For example, the win dividend D₁, which is $3.00, may be expressed as odds of 2 to 1. As used in this document, including in the claims, the term ‘win dividend’ is to be construed so as to include the corresponding odds.

In some embodiments the dividends remain fixed throughout the period in which wagers are being taken. However, in the illustrated embodiment, which is believed to be more typical of bookmaking practices, as wagers are placed the bookmaker has the freedom at step S5 of FIG. 2 to alter the win dividends that are being offered on some or all of the horses. This alteration is typically done by the bookmaker in response to market conditions and in particular supply and demand. If a bookmaker needs to compete more aggressively with other bookmakers to attract wagers, then that bookmaker can increase the win dividends on one or more of the horses. Conversely, if the bookmaker has received a high volume of wagers on a particular horse, the bookmaker may choose to reduce the win dividends being offered on one or more of the horses. A typical strategy pursued by some bookmakers when deciding how to alter the odds for the horses is to attempt to ‘balance the books’, such that the bookmaker stands to make a profit regardless of the particular horse that pays a dividend. As the process flow loops through steps S3, S4 and S5; the bookmaker publishes the revised win dividends or odds. This continues until the wagering period ends, which is typically within a predetermined time prior to commencement of the horse race. The conclusion of the wagering period is determined by the loop limiter at step S6 of FIG. 2 and the process flow then proceeds to step S7, which is the running of the horse race.

Once the horse race has been run, at step S8 of FIG. 2 the bookmaker reviews the finishing order and is liable to pay out against the wagers that were made on the horses that finished 4^{th}, 3^{rd}, 2^{nd} and 1^{st} in accordance with the win dividends D₁, D₂, D₃ and D₄ for those horses. In the embodiment in which the win dividends may be altered, it is the win dividends as they existed when the placement of wagers ceased that are used to calculate the pay out amounts.

The above embodiments have utilised values for n=10 and 4. However, it is open to the gaming method operator to use other values for n. Typically, it may be appropriate to define a higher value for n in relation to events having many participants. For example, it maybe appropriate to define n=100 for a marathon having thousands of competitors. Similarly, for events with a less number of competitors, a lower value for n may be deemed suitable.

The use of variables in this document, including in some of the claims, is intended to aid the clarity of disclosure. The particular letters selected as the variables (i.e. n, Pₙ, Pₚ, Fₚ, etc) are not intended as limitations to the scope of the claims. Rather, it is the mathematical relationships embodied in the formulas that are intended to limit the scope of the claims in which formulas appear. Additionally, the use of a particular form for a formula shall be taken to include all other mathematically equivalent forms of that formula and all other methods for approximating the mathematical relationship that is inherent in the formula. For example it will be appreciated that the formula N=n(n+1)÷2 is mathematically equivalent to, and therefore includes within its scope, the following formula:

$$N = {\sum }_{i = 1}^{i = n} i$$

The step of “defining a constant integral number n that is less than the number of event participants and that is greater than, or equal to, two” as disclosed in this document, including in the claims, is intended to be construed broadly. If an operator of a gaming method accepts wagers on participants finishing within the top n finishing positions of an event, then this is to be taken as confirmation that the operator defined n as per the above-quoted step.

As used in this document, including within the claims, terms such as “inverse relationship” are to be construed in a manner whereby an inverse relationship between two variables means that as one variable increases, the other variable decreases.

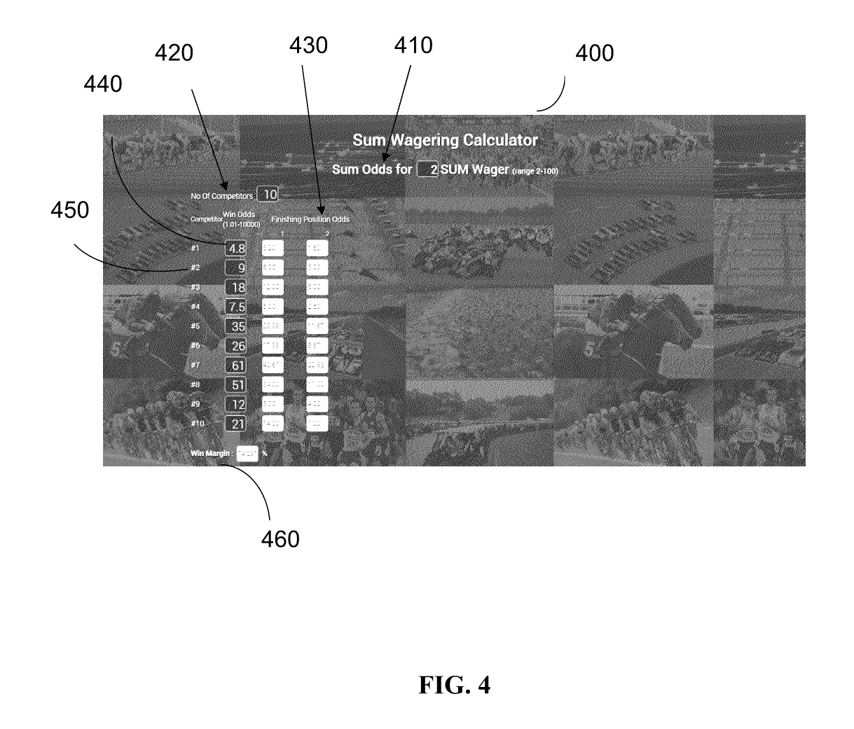

FIG. 4 illustrates a screenshot 400 of applicant's Sum Wagering™ calculator calculating dividends for 1st and 2^{nd} finishing positions. The screenshot 400 displays a menu option 420 for listing the number of competitors; each competitor 450 is displayed vertically. Win only odds 440 are displayed for information purpose, however they can assume any value between 1.01-10000. Based on any particular value of winning odd 440, the dividends for 1st and 2^{nd} positions are respectively calculated as finishing position odds 430. The present screenshot 400 shows sum odds 410 for first two finishing positions in the competition. Likewise, sum odds 410 can have any value ranging from 2-100. A win margin percentage 460 is displayed at the bottom for bettor's information purposes only.

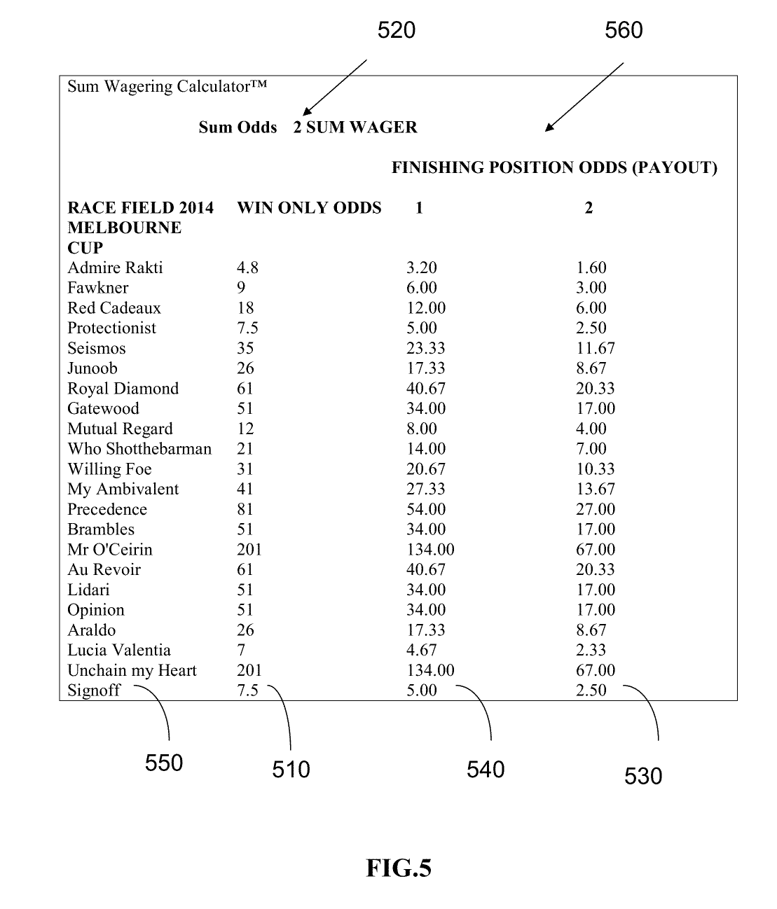

FIG. 5 illustrates an example of Sum Wagering™ calculator calculating dividends or payouts for first two finishing positions in the competition. The table shows sum odds 520 equivalent to 2 for winners finishing in the first two positions of the tournament. Competitors 550 are displayed vertically from top to bottom. Winning or win only odds 510 are displayed adjacent to the names of the competitors for information purposes only; the win only odds are the odds based on which the dividends are calculated. Thus, based on the value of Winning odds 510; the finishing position odds or payouts 560 are calculated for the first 540 and second winning position 530 respectively.

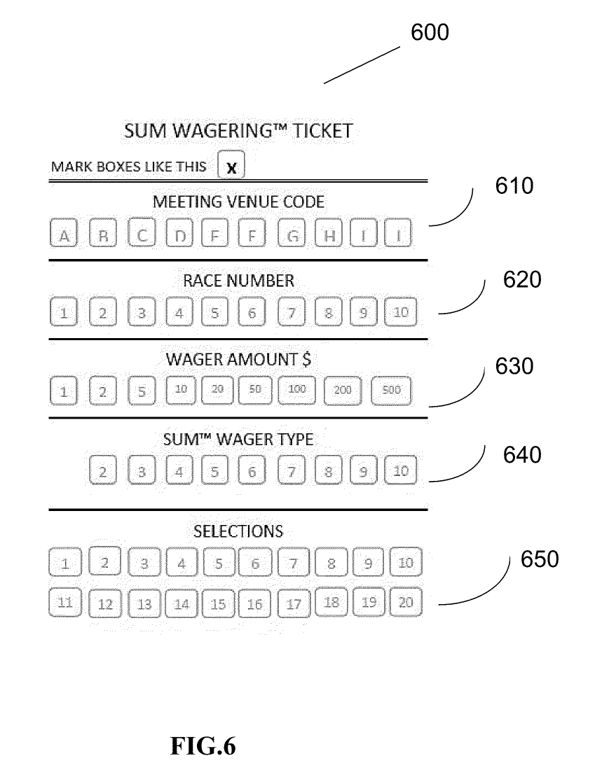

FIG. 6 shows a Sum Wagering Ticket™ 600. The wager shall select from the given options of meeting venue code 610, race number 620, wager amount 630, wagering type 640, and selection of the competitors 650. The wager shall mark the preferences in the boxes provided; otherwise the wager may be deemed invalid for lack of information.

While a number of preferred embodiments have been described, it will be appreciated by persons skilled in the art that numerous variations and/or modifications may be made to the invention without departing from the spirit or scope of the invention as broadly described. The term ‘prize’ and ‘dividend’ are interchangeably used in the specification disclosed above. The present embodiments are, therefore, to be considered in all respects as illustrative and not restrictive.

What is claimed is:

1. A gaming method relating to an event having a number of event participants, wherein the event determines a finishing order for at least some event participants, the method including:
prior to the event, defining a constant integral number n that is less than the number of event participants and that is greater than, or equal to, two;
prior to the event, accepting a plurality of wagers, each of the wagers being on at least one of the event participants; and
subsequent to the event, being responsive to a top n of the finishing order so as to determine eligibility for a dividend for each wager made on an event participant that finished within the top n finishing positions;
wherein an inverse relationship exists between each of the top n finishing positions and the dividend amount respectively associated with each of the top n finishing positions.

2. A gaming method according to claim 1 wherein each of the dividend amount respectively associated with each of the top n finishing positions is a pool amount available to be paid out across each wager on one of the top n finishing positions.

3. A gaming method according to claim 2 wherein a base prize pool amount Pₙ is associated with the n^{th} finishing position and wherein a dividend pool amount Pₚ is associated with the p^{th} finishing position, where p is less than n, the dividend pool amount Pₚ being given by the following formula:
Pₚ=Pₙ×Fₚ
where Fₚ is a factor that is inversely related to p.

4. A gaming method according to claim 3 wherein factor Fₚ is given by the following formula:
Fₚ=n+1−p.

5. A gaming method according to claim 3 wherein factor Fₚ is given by the following formula:
Fₚ=(n+1−p)².

6. A gaming method according to claim 3 wherein the base dividend pool amount Pₙ is given by the following formula:
Pₙ=T÷N
T being a total available dividend pool; and
N being given by the following formula:
N=n(n+1)÷2.

7. A gaming method according to claim 6 wherein the total available dividend pool is equal to a total amount wagered minus a withheld amount.

8. A gaming method according to claim 7 wherein the withheld amount includes an operator's profit amount, a costs amount and a tax amount.

9. A gaming method according to claim 1 wherein each of the dividend amount respectively associated with each of the top n finishing positions is a win dividend that determines a payout amount that is payable for each wager on a participant that finishes in one of the top n finishing positions.

10. A gaming method according to claim 10 wherein a base win dividend Dₙ is associated with the n^{th} finishing position and wherein a win dividend Dₚ is associated with the p^{th} finishing position, where p is less than n, the win dividend Dₚ being given by the following formula:
Dₚ=Dₙ×Fₚ
where Fₚ is a factor that is inversely related to p.

11. A gaming method according to claim 10 wherein factor Fₚ is given by the following formula:
Fₚ=n+1−p.

12. A gaming method according to any one of claim 10 wherein the win dividend associated with the n^{th} finishing position is calculated by the following formula:
Dₙ=T÷N
Wherein N=n(n+1)÷2.

13. A gaming method according to claim 10 wherein some of the win dividends may be altered in response to the market conditions during a period in which wagers are being accepted.

14. A gaming method according to claim 10 wherein the win dividends remain fixed during a period in which wagers are being accepted.

15. A computerised apparatus for implementing a gaming method relating to an event having a number of event participants, wherein the event determines a finishing order for at least some event participants, the computerised apparatus being programmed to:
store a constant integral number n that is less than the number of event participants and that is greater than, or equal to, two;
store a plurality of wagers, each of the wagers being on at least one of the event participants; and
process a top n of the finishing order so as to determine eligibility for a dividend for each wager made on an event participant that finished within the top n finishing positions;
wherein an inverse relationship exists between each of the top n finishing positions and a dividend amount respectively associated with each of the top n finishing positions.

17. A computerised apparatus for implementing a gaming method relating to an event having a number of event participants, wherein the event determines a finishing order for at least some event participants, the computerised apparatus being programmed to:

18. The user interface implementing a gaming method relating to an event having a number of event participants, wherein the event determines a finishing order for at least some event participants, the display elements of the user interface comprising:
a wagering calculator calculating dividends for top n finishing positions;
a menu option for listing the number of competitors;
a win margin percentage displayed at the bottom of the display element for information purpose;

19. The user interface implementing the gaming method according to claim 18 wherein:
competitors are displayed vertically in the user interface;
win only odds are displayed adjacent to the competitors;
dividends for top n finishing positions are displayed adjacent to the win only odds.

20. The user interface implementing the gaming method according to claim 19 wherein:
win only odds may assume any value between 1.01-10000;
top n positions may have any value ranging from 2-100.
